(19) United States
(12) Patent Application Publication
(10) Pub. No.: US 2026/0040392 A1
(43) Pub. Date: Feb. 5, 2026

(54) METHODS FOR ENABLING NETWORK ENERGY SAVING USING SBFD

(71) Applicant: INTERDIGITAL PATENT HOLDINGS, INC., Wilmington, DE (US)

(72) Inventors: Aata El Hamss, Laval (CA); Jonghyun Park, Syosset, NY (US); Paul Marinier, Brossard (CA); Moon IL Lee, Melville, NY (US); Faris Alfarhan, Montreal (CA); Nazli Khan Beigi, Longueuil (CA); Virgile Garcia, Antibes (FR)

(73) Assignee: INTERDIGITAL PATENT HOLDINGS, INC., Wilmington, DE (US)

(21) Appl. No.: 18/794,553

(22) Filed: Aug. 5, 2024

(51) Int. Cl. H04W 76/28; H04L 5/14

(52) U.S. Cl. CPC H04W 76/28; H04L 5/14

(57) ABSTRACT

A method and wireless transmit/receive unit (WTRU) for enabling network energy saving using sub-band full duplex (SBFD) operation. The WTRU receives, from a gNode-B (gNB), a sub-band full duplex (SBFD) configuration. The WTRU receives, from the gNB, a cell discontinuous reception (DRX) configuration indicative of a cell DRX active period and a cell DRX periodicity. The WTRU then determinses that a latency parameter associated with packet data for transmission is longer than the cell DRX periodicity. The WTRU transmits, to the gNB, a request using a preconfigured uplink resource. The WTRU then receives, from the gNB, an indication of SBFD resources for uplink transmission during a cell DRX inactive period. The WTRU then transmits, to the gNB, the packet data using the SBFD resources for uplink transmission.

### BACKGROUND

There are two modes of operation in current cellular communication systems: Frequency Division Duplex (FDD) and Time Division Duplex (TDD). In FDD mode, DL and UL transmissions can be configured at the same time but using different carrier frequencies. In TDD mode, the DL and UL transmissions are separated in the time domain. This time restriction can impact the coverage of the transmission especially for uplink transmissions. To solve this limitation of the resource availability in one direction (DL or UL), full duplex was studied to be supported in NR systems.

Full duplex includes the gNB and/or WTRU transmitting and receiving signals in the same carrier bandwidth at the same time. In the recent 3GPP full duplex study item, the sub-band full duplex (SBFD) concept was introduced where a carrier is divided into multiple sub-bands and each sub-band will have transmissions only one direction. For example, one SBFD configuration could be to divide a carrier into three sub-bands, with a first sub-band configured for downlink transmission, a second sub-band configured for uplink transmission, and a third sub-band configured for downlink transmission. (See FIG. 2 discussed in more detail below.) The three sub-bands can be separated by a gap in the frequency domain to protect the transmissions from cross link interference (CLI).

Network energy saving (NES) is used by the network to save energy by turning off the transmitter and/or the receiver for a period of time. The gNB can save energy by not transmitting and/or receiving for period of time. The period when the gNB is transmitting/receiving is defined as an active period, and the period when the gNB is not transmitting/receiving is defined as a non-active period. The gNB configures the WTRU with cell DTX/DRX patterns that indicates the active and non-active periods.

### SUMMARY

A method and wireless transmit/receive unit (WTRU) for enabling network energy saving using sub-band full duplex (SBFD) operation. The WTRU receives, from a gNode-B (gNB), a sub-band full duplex (SBFD) configuration. The WTRU receives, from the gNB, a cell discontinuous reception (DRX) configuration indicative of a cell DRX active period and a cell DRX periodicity. The WTRU then determinses that a latency parameter associated with packet data for transmission is longer than the cell DRX periodicity. The WTRU transmits, to the gNB, a request using a preconfigured uplink resource. The WTRU then receives, from the gNB, an indication of SBFD resources for uplink transmission during a cell DRX inactive period. The WTRU then transmits, to the gNB, the packet data using the SBFD resources for uplink transmission.

In some embodiments, the SBFD resources for uplink transmission may overlap with an SBFD downlink transmission by the gNB. For example, the SBFD resources for uplink transmission overlap with a synchronization signal/physical broadcast channel (PBCH) block (SSB) transmission by the gNB. Or the SBFD resources for uplink transmission overlap with a paging occasion, a physical downlink control channel (PDCCH) occasion, or a reference signal.

In some embodiments, the latency parameter associated with packet data for transmission is associated with a logical channel associated with the packet data for transmission. The preconfigured uplink resource may be a physical uplink control channel (PUCCH) resource. Or, the preconfigured uplink resource is an SBFD resource during a cell DRX inactive period.

In some embodiments, the WTRU retransmits the request to the gNB using a preconfigured uplink resource.

In some embodiments, the indication of SBFD resources for uplink transmission during a cell DRX inactive period is received in a physical downlink control channel (PDCCH) search space.

In some embodiments, the WTRU receives, from the gNB, an indication that SBFD resources for uplink transmission during a cell DRX inactive period are no longer available.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example of sub-band full duplex (SBFD) operation;

FIG. 3 is an illustration of a cell DRX configuration showing additional uplink resources using SBFD in the cell DRX inactive periods;

FIG. 4 is a method flow diagram performed by a WTRU for requesting an additional cell DRX active period using SBFD in the cell DRX inactive periods;

FIG. 5 is an illustration of a cell DTX configuration showing additional downlink resources using SBFD in the cell DTX inactive periods; and

FIG. 6 is a method flow diagram performed by a WTRU for utilizing an additional cell DTX active period using SBFD in the cell DTX inactive periods.

### DETAILED DESCRIPTION

The following acronyms are used in this detailed description and have the following definitions:
ACK Acknowledgement
BLER Block Error Rate
BWP Bandwidth Part
CAP Channel Access Priority
CAPC Channel access priority class
CCA Clear Channel Assessment
CCE Control Channel Element
CE Control Element
CG Configured grant or cell group
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
eLAA enhanced Licensed Assisted Access
FeLAA Further enhanced Licensed Assisted Access
HARQ Hybrid Automatic Repeat Request
LAA License Assisted Access
LBT Listen-Before-Talk
LTE Long Term Evolution e.g. from 3GPP LTE R8and up
NACK Negative ACK
MCS Modulation and Coding Scheme
MIMO Multiple Input Multiple Output
NR New Radio

OFDM Orthogonal Frequency-Division Multiplexing
PHY Physical Layer
PID Process ID

PO Paging Occasion
PRACH Physical Random Access Channel
PRB Physical Resource Block
PSS Primary Synchronization Signal
RA Random Access (or procedure)
RACH Random Access Channel
RAR Random Access Response
RB Resource Block
RCU Radio access network Central Unit
RF Radio Front end
RLF Radio Link Failure
RLM Radio Link Monitoring
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SDU Service Data Unit
SRS Sounding Reference Signal
SS Synchronization Signal
SSS Secondary Synchronization Signal
SWG Switching Gap (in a self-contained subframe)
SPS Semi-persistent scheduling
SUL Supplemental Uplink
TB Transport Block
TBS Transport Block Size
TRP Transmission/Reception Point
TSC Time-sensitive communications
TSN Time-sensitive networking
UL Uplink
URLLC Ultra-Reliable and Low Latency Communications
WBWP Wide Bandwidth Part
WLAN Wireless Local Area Networks and related technologies (IEEE 802.xx domain)

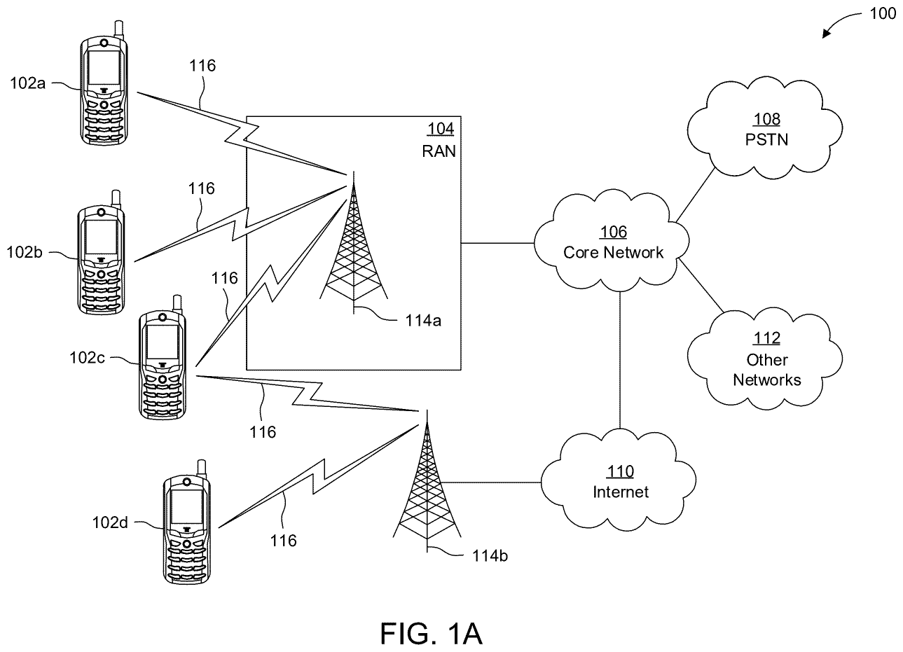

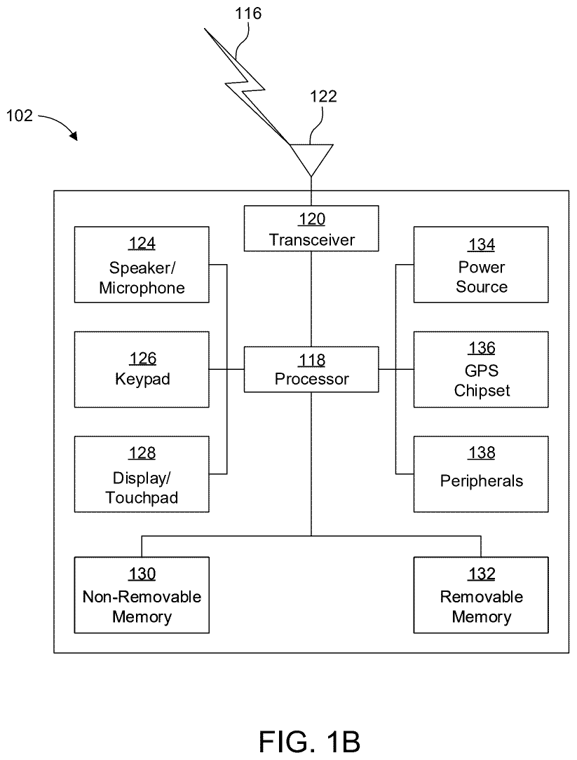

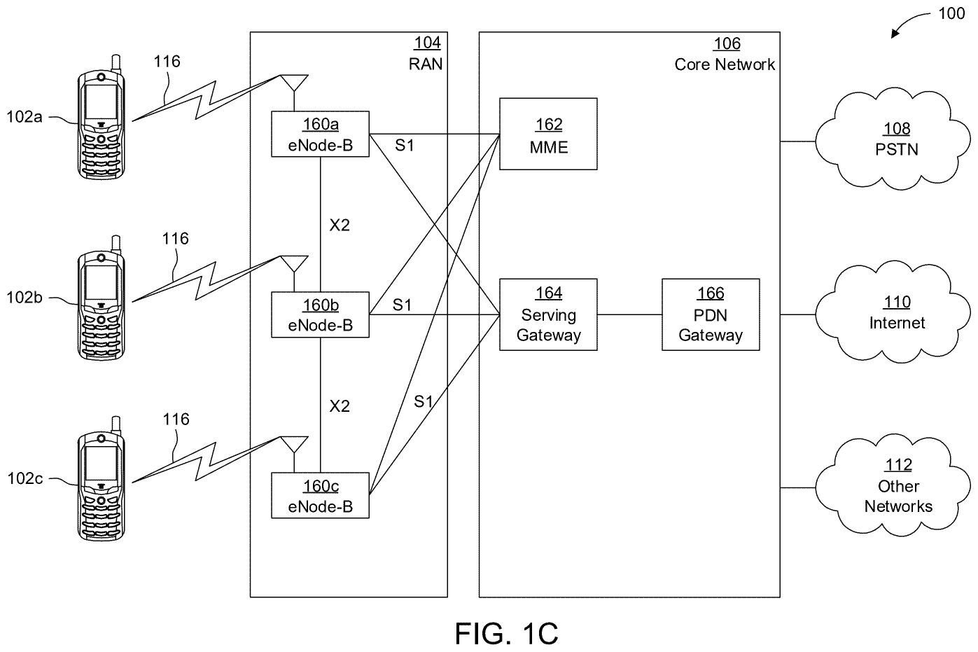

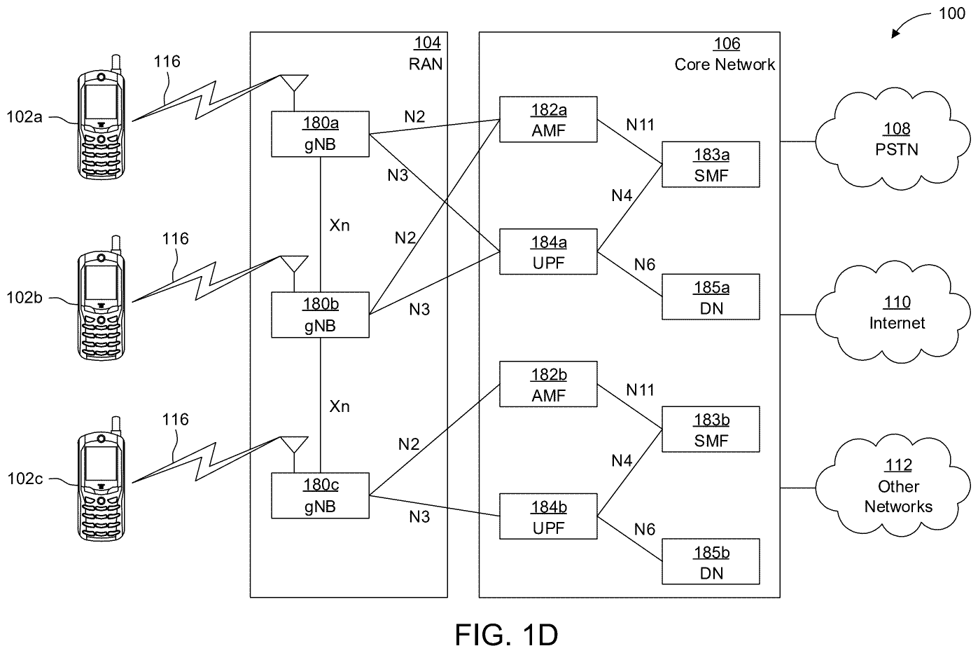

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHZ, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b , 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As used herein, the term “subband” is used to refer to a frequency-domain resource and may be characterized by at least one of the following: a set of resource blocks (RBs), a set of resource block sets (RB sets), e.g. when a carrier has intra-cell guard bands, a set of interlaced resource blocks, a bandwidth part, or portion thereof, and/or a carrier, or portion thereof. For example, a subband may be characterized by a starting RB and number of RBs for a set of contiguous RBs within a bandwidth part. A subband may also be defined by the value of a frequency-domain resource allocation field and bandwidth part index.

As used herein, the term subband full duplex “SBFD” is used to refer to a subband-wise duplex (e.g., either UL or DL being used per subband) and may be characterized by at least one of the following: Cross Division Duplex (e.g., XDD, subband-wise FDD within a TDD band), subband-based full duplex (e.g., full duplex as both UL and DL are used/mixed on a symbol/slot, but either UL or DL being used per subband on the symbol/slot), frequency-domain multiplexing (FDM) of DL/UL transmissions within a TDD spectrum, a subband non-overlapping full duplex (SBFD) (e.g., non-overlapped sub-band full-duplex), a full duplex other than a same-frequency (e.g., spectrum sharing, subband-wise-overlapped) full duplex, and/or an advanced duplex method, e.g., other than (pure) TDD or FDD, e.g., partial in-band full duplex, subband overlapping full duplex, in-band full duplex (IBFD).

As used herein, a property of a grant or assignment may include of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and/or any parameter provided in a DCI, by MAC or by RRC for the scheduling the grant or assignment.

As used herein, an indication by DCI may include of at least one of the following: an explicit indication by a DCI field or by RNTI used to mask CRC of the PDCCH; and/or an implicit indication by a property such as DCI format, DCI size, Coreset or search space, Aggregation Level, first resource element of the received DCI (e.g., index of first Control Channel Element), where the mapping between the property and the value may be signaled by RRC or MAC.

As used herein, the term “signal” may be interchangeably with one or more of following: Sounding reference signal (SRS); Channel state information-reference signal (CSI-RS); Demodulation reference signal (DM-RS); Phase tracking reference signal (PT-RS); and/or Synchronization signal block (SSB).

As used herein, the term downlink reception may be used interchangeably with Rx occasion, PDCCH, PDSCH, and/or SSB reception.

As used herein, the term uplink transmission may be used interchangeably with Tx occasion, PUCCH, PUSCH, PRACH, and/or SRS transmission.

As used herein, the term reference signal (RS) may be interchangeably used with one or more of RS resource, RS resource set, RS port, and/or RS port group. Further, RS may be interchangeably used with one or more of SSB, CSI-RS, SRS, and/or DM-RS,

As used herein, the term time instance may be interchangeably used with slot, symbol, and/or subframe.

As used herein, the terms UL-only and DL-only Tx/Rx occasions may interchangeably be used with legacy TDD UL or legacy TDD DL, respectively. For example, the legacy TDD UL/DL Tx/Rx occasions may occur where SBFD is not configured and/or where SBFD is disabled.

In some scenarios, a WTRU may be configured to operate in Sub-band Full Duplex (SBFD) in the frequency domain. The SBFD frequency domain configuration can be associated with a carrier frequency, or alternatively it may be associated with a Bandwidth Part (BWP) of a carrier frequency. The SBFD frequency domain configuration allocates some RBs of the BWP/carrier for uplink transmission and other RBs of the BWP/carrier for downlink transmission. The UE can be configured with SBFD frequency domain configuration using dedicated RRC signaling or common broadcast signaling e.g., SIB signaling. Hereafter, the RB(s) or RE(s) may be interchangeably be used with RE(s), RB(s), REG(s), RBG(s), frequency-unit(s), subband(s), band(s), BWP(s), and/or component carrier(s), e.g., any frequency-domain granularity as frequency-unit may be applicable in terms of whether full duplex (SBFD) operation may be performed on one or more frequency-units.

In SBFD operation, the UE can be configured with a time domain configuration that indicates a slot configuration for the SBFD operation (i.e., SBFD time domain configuration). For example, the UE may be configured with a first set of slots that have only SBFD symbols, a second set of slots that have only non-SBFD symbols (i.e., symbols where the entire BWP or carrier is configured for either UL or DL) and a third set of slots that have both SBFD and non-SBFD symbols. The UE may be configured with an SBFD time domain configuration using dedicated RRC signaling or common broadcasted signaling e.g., SIB signaling. Hereafter, the slot(s) or symbol(s) may be interchangeably used with symbol(s), slot(s), sub-frame(s), frame(s), time-unit(s), e.g., any time-domain granularity as time-unit may be applicable in terms of whether full duplex (e.g., SBFD) operation may be performed on one or more time-units.

In an example, a WTRU may receive one or more configurations for SBFD operation. The one or more configurations may include information on time resources (e.g., symbols, slots, etc.) where the SBFD (e.g., full duplex operation performed at gNB) is applied. The configurations may include information on frequency resources in the configured SBFD time resources, for example for a first UL subband, a first DL subband, a first guard band, a first sidelink SB, a first Flexible SB, and so forth. The WTRU may receive the configuration infromations via a DCI, MAC-CE, RRC signaling, a system information block (SIB), a broadcast message, and/or a multicast message toward a group of UEs.

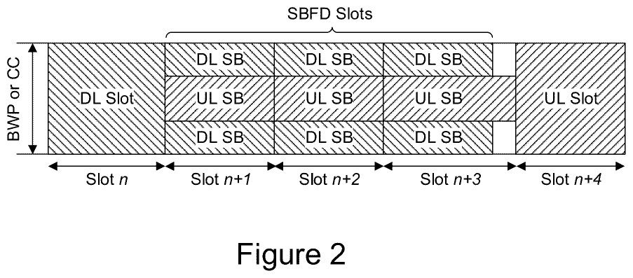

Referring to FIG. 2, the SBFD configuration is shown. In the frequency domain, the configuration exists in the BWP or CC. In the time domain, the SBFD configuration exists in slots n to slot n+4. In slot n, a DL slot occupies the entire frequency BWP or CC. In slots n+1 through slot n+3, DL SBs and UL SBs occupy these SFBD slots. In the DL SBs, a gNB may transmit DL signals to WTRUs. In the same slots but in the UL SBs, WTRUs may transmit UL signals to the gNB. In slot n+4, an UL slot occupies the entire BWP or CC. The SBFD slots allow simultaneous UL and DL on different subbands within a same slot.

In some scenarios, the WTRU may operate in half-duplex (HD) operation based on the configurations, where the WTRU may either transmit an UL (or sidelink) signal or receive a DL (or sidelink) signal in a configured (or indicated) SBFD time instance. In another example (e.g., if configured by the gNB), the UE may operate in full-duplex (FD) operation (e.g., subband non-overlapping FD (SBFD), subband partially/fully-overlapping FD) using the first set of SBFD configurations, where the UE may both transmit an UL (or sidelink) signal and receive a DL (or sidelink) signal in a configured (or indicated) SBFD time instance.

Separate from SBFD operation, the network may operate in a cell DRX mode. The WTRU may be configured with a cell DRX pattern that consists of periodic active-periods and non-active periods. During the cell DRX active period, the WTRU assumes that the gNB is awake and can receive uplink transmissions. The WTRU may transmit pre-configured uplink transmissions (e.g., SR/PRACH/PUCCH/PUSCH) during a cell DRX active-period. During the cell DRX non-active period, the WTRU assumes that the gNB is in a sleep mode and cannot receive uplink transmissions. The cell DRX configuration may include information about active-period duration followed by non-active period duration and periodic repetition of the active period and non-active period, i.e., cell DRX periodicity. As used herein, the term DRX refers to cell DRX as described in this paragraph.

Independent from cell DRX, the network may also operate in a cell DTX mode. The WTRU may be configured with a cell DTX pattern that includes periodic active periods and non-active periods. During the cell DTX active period, the WTRU assumes that the gNB is awake and can transmit downlink transmissions. The WTRU may monitor downlink transmissions (e.g., PDCCH/PDSCH/Reference Signals) during cell DTX active periods. During the cell DTX non-active period, the WTRU assumes that the gNB is in sleep mode and may not transmit downlink transmissions. The cell DTX configuration may include information about active period duration followed by non-active period duration and periodic repetition of the active period and non-active period i.e., cell DTX periodicity. As used herein, the term DTX refers to cell DTX as described in the paragraph.

In some scenarios, the WTRU may be configured with multiple cell DRX and/or cell DTX configurations. Each cell DRX configuration or cell DTX configuration may have different active period durations, non-active period durations and periodicities. In some scenarios, the WTRU may be configured with multiple cell DRX configurations and/or cell DTX configurations, and only one configuration is enabled at a given time. In such a scenario, the WTRU uses the active period duration and non-active period duration of the enabled configuration. In other scenarios, the WTRU may be configured with multiple cell DRX and/or cell DTX configurations, and more than one configuration is enabled at a given time. In such scenarios, the WTRU uses the active period duration that is equal to the sum of all active period durations of the enabled configuration (i.e., the WTRU assumes that the gNB is monitoring and receiving transmissions on all the active durations of each cell DRX configuration), or non-active period duration that is equal to the sum of all non-active period durations of the enabled configuration (i.e., the WTRU assumes that the gNB is not monitoring and not receiving transmissions on all the non-active durations of each cell DRX configuration). When the WTRU is configured with multiple cell DRX and/or cell DTX configurations, the WTRU may receive an indication to begin using one or more of the cell DRX and/or cell DTX configurations using dynamic signaling such as DCI and/or MAC CE or semi-static signaling such as RRC signaling.

In some embodiments, when the WTRU is configured with a cell DTX and/or cell DRX configuration, the WTRU may require additional resources for either UL or DL transmissions, for example to meet latency requirements. In these scenarios, the WTRU may obtain additional cell DTX and/or cell DRX active period duration. In one embodiment, the additional cell DTX and/or cell DRX active period duration occurs during non-active period duration slots. In another embodiment, the additional cell DTX and/or cell DRX active period duration may be a different cell DTX and/or cell DRX configuration that is enabled simultaneously along with the already enabled cell DTX and/or cell DRX configuration. In these embodiments, SBFD operation enables uplink transmission during DRX inactive periods when the gNB will be transmitting downlink signals to maintain system operation, like SSB, for example. Similarly, SBFD operation enables downlink transmissions during DTX inactive periods when the gNB will be receiving uplink signals to maintain system operation, like PRACH, for example.

In one embodiment, the WTRU may be configured with cell bandwidth to be used for uplink when the gNB indicates a cell DTX active period duration. In other words, during a cell DTX active period, the WTRU may transmit on the uplink using SBFD at the same time as the gNB transmits on the downlink during the cell DTX active period. When a cell DTX active period duration is configured, the entire bandwidth is available for uplink transmission by the WTRU using SBFD while the gNB may transmit some possible downlink transmissions, e.g., RAR. The cell DTX pattern can restrict the downlink transmission to only a set of signals instead of turning off the whole DL transmission

Similarly, the WTRU may be configured with cell bandwidth to be used for downlink when the gNB indicates a dell DRX active period duration. In other words, during a cell DRX active period, the WTRU may receive on the downlink using SBFD at the same time as the gNB receives on the uplink during the cell DRX active period. When a cell DRX active period duration is configured, the entire bandwidth is available for downlink reception by the WTRU using SBFD while the gNB may receive some possible uplink transmissions, e.g. ACK/NACK. The cell DRX pattern may restrict the uplink transmissions to only a set of signals instead of turning of the whole UL transmission.

To enable the additional cell DTX and/or cell DRX active period durations, an association between one or more SBFD configurations and cell DTX and/or cell DRX configuration may be established. The WTRU may be configured with an association between SBFD configuration and a cell DRX and/or a cell DTX configuration. When the UE is configured with an association between an SBFD configuration and a cell DRX configuration, the SBFD configuration can include an uplink sub-band for limited uplink transmissions. Such limited uplink transmissions can include one or more of the following: PRACH transmissions, scheduling request (SR) transmissions for high priority data, and/or PUCCH carrying ACK/NACK for high priority transmissions.

When the WTRU is configured with an association between an SBFD configuration and a cell DTX configuration, the SBFD configuration may include a downlink sub-band for limited downlink transmissions. Such limited downlink transmissions may include one or more of the following: SSB transmissions, PDCCH transmissions, CSI-RS transmissions, and/or Wake-up signal transmissions.

In some embodiments, the WTRU may be configured with a first SBFD configuration that is associated with cell DRX and/or cell DTX active period duration and a second SBFD configuration that is associated with a cell DRX and/or cell DTX non-active period duration. When the WTRU is operating during the active period duration, the WTRU uses the first SBFD configuration. When the WTRU is operating during the non-active period duration, the WTRU uses the second SBFD configuration.

In some embodiments, the WTRU may be configured to autonomously determine on which set of slots and/or symbols an SBFD configuration is valid. For example, the WTRU is configured with an SBFD configuration that is associated with cell DRX and/or cell DTX non-active period. The WTRU is not configured with which set of slots and/or symbols from the cell DRX and/or cell DTX non-active period in an SBFD configuration that is determined valid.

As mentioned above, the WTRU may determine the cell DTX and/or cell DRX configuration based on the SBFD configuration. The WTRU may determine what is the DRX configuration (active period, inactive period, periodicity, etc.) and what signals/transmissions are allowed to be transmitted during cell DRX mode inactive periods. The WTRU may determine what is the cell DTX configuration (active period, inactive period, periodicity, etc.) and what signals/transmission are expected to be received during cell DTX mode inactive periods.

As mentioned above, the WTRU may request additional active duration during a cell DRX and/or cell DTX configuration. In some embodiments, the WTRU may be configured with a logical channel latency parameter that is associated with a logical channel and/or logical channel group. The logical channel latency parameter indicates to the WTRU the maximum latency a data packet can tolerate. For example, such a parameter can indicate the number of slots between the slot when the transmission is available, and the maximum slot on which the logical channel/logical channel group should be transmitted. In another example, a logical channel latency parameter indicates, in milliseconds, for example, the maximum duration between the slot when the transmission is available, and the maximum slot on which the logical channel/logical channel group should be transmitted. The WTRU may be configured with multiple logical channel latency parameters, each one associated with different logical channels and/or logical channel groups. The WTRU may associate each logical channel/logical channel group with a logical channel latency parameter.

In some embodiments, the WTRU may be configured with a packet delay budget (PDB) that is associated with a logical channel, logical channel group, and/or QoS flow. The PDB indicates to the WTRU the maximum latency a data packet can tolerate. For example, a PDB may indicate the maximum duration in milliseconds from the slot when the data packet is available for transmission and the actual slot on which the logical channel/logical channel group will be transmitted. The WTRU may be configured with multiple logical channel latency parameters each one is associated with different logical channel/logical channel group.

In some embodiments, the WTRU may be configured to determine whether additional cell DRX active duration is needed for a logical channel. The WTRU may be configured to determine whether additional cell DRX active duration is needed based on the configured (and enabled) cell DRX periodicity and the logical channel latency parameter. If the enabled cell DRX periodicity is longer than the logical channel latency parameter, the WTRU requests additional cell DRX active duration. Otherwise, the WTRU waits until the next cell DRX active period to transmit the data corresponding to the logical channel. The WTRU transmits a request for additional cell DRX active duration using a pre-configured uplink resource. The request may be carried on a physical channel or in MAC CE or RRC signaling. The pre-configured uplink resource can be PUCCH resource (e.g., a short PUCCH signal, analogous to scheduling request (SR)), PUSCH resource, or PRACH-like resource.

The WTRU may be configured to determine whether additional cell DRX active duration is needed or not based on a priority associated with the logical channel. For example, the WTRU may determine that a priority associated with a logical channel is higher than a threshold and the WTRU requests additional cell DRX active duration from the gNB in such a circumstance.

When the WTRU requests additional cell DRX active duration using a pre-configured uplink resource, the WTRU may in some instances need to retransmit the request of additional cell DRX active duration. The WTRU may be configured to retransmit based on one or more of the following conditions. After transmitting the request, the WTRU does not receive any configuration for additional cell DRX active duration. Or, after transmitting the request, the WTRU does not receive any downlink transmission scheduling uplink resources before the next cell DRX active duration.

As mentioned, the WTRU may be configured with a special uplink resource to request additional cell DRX active duration and/or retransmit the request for additional cell DRX active duration. The special uplink resource may be a PUCCH and/or PUSCH resource. In one embodiment, the special uplink resource may be configured within the cell DRX active period. In another embodiment, the special uplink resource may be configured within the cell DRX non-active period. For example, the WTRU may be configured with an SBFD configuration within the SSB slots that configures some uplink resources along with the SSB transmission, e.g., SBFD with a DL sub-band for SSB and an UL sub-band for special uplink resources. The special uplink resource may be a configured grant that has a fewer number of PRBs.

As mentioned, the WTRU may request and receive additional cell DRX active period duration. Such additional cell DRX active period duration may be communicated to the WTRU specifically using dedicated UE signaling, or alternatively, the cell DRX active period duration can be communicated to a group of WTRUs using group common signaling. The WTRU may be configured to monitor a PDCCH in a search space set configured for monitoring possible additional cell DRX active period configuration information within the cell DRX active period. Alternatively, the WTRU may be configured to monitor a PDCCH in a search space set configured for monitoring additional cell DRX active period configuration information within the cell DRX non-active period.

To enable an additional cell DRX active period configuration, the WTRU may receive an indication from the gNB to use one of the SBFD configurations associated with a cell DRX configuration and the SSB index. For example, the gNB may indicate to the WTRU, using a group common DCI, the SBFD configuration and the SSB index. The WTRU may determine a set of symbols and uplink resources for the additional cell DRX active period duration based on the indicated SBFD configuration and the indicated SSB index, and/or SSB period, and/or SSB offset. For example, each SSB index, and/or SSB period, and/or SSB offset may be associated with a number of slots/symbols, and the WTRU determines the set of symbols and uplink resources for the additional cell DRX active period duration using the association.

To enable an additional cell DRX active period, the WTRU may receive an indication from the gNB to use one of the SBFD configurations associated with a cell DRX configuration and a paging occasion. For example, the gNB may indicate to the WTRU, using a group common DCI, the SBFD configuration and the paging occasion. The WTRU may determine a set of symbols and uplink resources for the additional cell DRX active period duration based on the indicated SBFD configuration and the indicated paging occasion. For example, each paging occasion may be associated with a number of slots/symbols and the WTRU determines the set of symbols and uplink resources for the additional cell DRX active period duration using the association.

To enable an additional cell DRX active period, the WTRU may receive an indication from the gNB to use one of the SBFD configurations associated with a cell DRX configuration and a PDCCH occasion/search space set. For example, the gNB may indicate to the WTRU, using group common DCI, the SBFD configuration and a search space set index. The WTRU may determine the set of symbols and uplink resources for the additional cell DRX active period duration based on the indicated SBFD configuration and the indicated search space set index. For example, each search space set index may be associated with a number of slots/symbols and the WTRU determines the set of symbols and uplink resources for the additional cell DRX active period duration using the association.

To enable an additional cell DRX active period, the WTRU may receive an indication from the gNB to use one of the SBFD configurations associated with a DRX configuration and a reference signal, e.g., CSI-RS. For example, the gNB may indicate to the WTRU, using group common DCI, the SBFD configuration and the resource index of reference signal, e.g. CSI-RS. The WTRU may determine the set of symbols and uplink resources for the additional cell DRX active period duration based on the indicated SBFD configuration and the indicated reference signal, e.g. CSI-RS, resource index. For example, each reference signal, i.e. CSI-RS, resource/resource set may be associated with a number of slots/symbols and the WTRU determines the set of symbols and uplink resources for the additional cell DRX active period duration using the association.

Similarly, the WTRU may be configured with additional cell DTX active period duration. The WTRU may receive an additional cell DTX active period configuration. Such an additional cell DTX active period configuration may be configured to the WTRU specifically using dedicated WTRU signaling, or alternatively, the cell DTX active period configuration may be configured to a group of WTRUs using group common signaling. The WTRU may be configured to monitor a PDCCH in search space set configured for monitoring a possible additional cell DTX active period within the cell DRX active period. Alternatively, the WTRU may be configured to monitor a PDCCH in a search space set configured for monitoring a possible additional cell DTX active period within the cell DTX non-active period.

To enable an additional cell DTX active period, the WTRU may receive an indication from the gNB to use one of the SBFD configurations associated with a DTX configuration and a PRACH occasion. The WTRU may determine the set of symbols and downlink resources for the additional cell DTX active period duration based on the indicated SBFD configuration and the indicated PRACH occasion. For example, each PRACH occasion may be associated with a number of slots/symbols and the WTRU determines the set of symbols and downlink resources for the additional cell DTX active period duration using the association.

To enable an additional cell DTX active period, the WTRU may receive an indication from the gNB to use one of the SBFD configurations associated with a DTX configuration and a PUCCH occasion. The WTRU may determine the set of symbols and downlink resources for the additional cell DTX active period duration based on the indicated SBFD configuration and the indicated PUCCH occasion. For example, each PUCCH occasion may be associated with a number of slots/symbols and the WTRU determines the set of symbols and downlink resources for the additional cell DTX active period duration using the association.

To enable an additional cell DTX active period, the WTRU may receive an indication from the gNB to use one of the SBFD configurations associated with a DTX configuration and a PUSCH occasion. The WTRU may determine the set of symbols and downlink resources for the additional cell DTX active period duration based on the indicated SBFD configuration and the indicated PUSCH occasion. For example, each PUSCH occasion may be associated with a number of slots/symbols and the WTRU determines the set of symbols and downlink resources for the additional cell DTX active period duration using the association.

Upon determining additional cell DRX active period duration is available, the WTRU may determine the uplink resource to use for transmitting the logical channel with a logical channel parameter being shorter than the cell DRX configuration periodicity. In one embodiment, the WTRU may be configured with a configured grant within the additional cell DRX active period, and the configured grant is only activated after receiving the additional cell DRX active period. For example, an RRC configuration may configure the WTRU with a configured grant within a potential additional cell DRX active period. When the WTRU receives an indication of additional cell DRX active period duration, the indication may be used by the WTRU to activate the configured grant. In another embodiment, the WTRU may receive a dynamic grant along with or after receiving an indication of additional cell DRX active period duration. The WTRU may then transmit the uplink transmission in the UL sub-band of the SBFD configuration within the determined set of symbols. In another embodiment, the WTRU may receive a CG-activating (e.g., semi-persistent-scheduling (SPS)-activating) DCI for the configured grant that schedules at least one UL transmission occasion within the additional cell DRX active period, and the WTRU may determine that the activation-DCI (also) enables the additional cell DRX active period duration, where the WTRU may perform UL transmissions based on the configured grant and perform SBFD-related behaviors (e.g., DL reception on a DL subband) during the additional cell DRX active period duration.

In certain scenarios, the WTRU is configured to request disabling of the additional cell DRX active period. The WTRU may be configured to indicate to the gNB that the additional cell DRX active period is not needed, e.g. when the WTRU has no logical channel with a logical channel latency parameter shorter than the cell DRX periodicity. Such an indication may be transmitted by the WTRU in a PUCCH and/or PUSCH. In one embodiment, such an indication may be transmitted within the cell DRX active period. In another embodiment, the indication may be transmitted within the cell DRX non-active period.

In certain scenarios, the gNB may determine to disable additional cell DRX and/or cell DTX active periods. The WTRU may be configured to receive an indication that disables the additional cell DRX and/or cell DTX active period duration. In embodiment, the WTRU may be configured explicitly to disable the additional cell DRX and/or cell DTX active period duration. The indication may be carried in PDCCH, MAC CE, and/or RRC signaling. In another embodiment, the WTRU may be configured implicitly to disable the additional cell DRX and/or cell DTX active period duration. For example, the WTRU may be configured with a timer along with the additional cell DRX and/or cell DTX active period duration. Upon the timer expiry, the WTRU autonomously disables the additional cell DRX and/or cell DTX active period duration. Disabling the additional cell DRX and/or cell DTX active period duration means that the WTRU stops monitoring gNB transmissions and/or WTRU transmissions on the additional active period duration. In another embodiment, the WTRU may be configured to disable the additional cell DRX and/or cell DTX active period duration after receiving a reconfiguration of the cell DRX and/or cell DTX configuration.

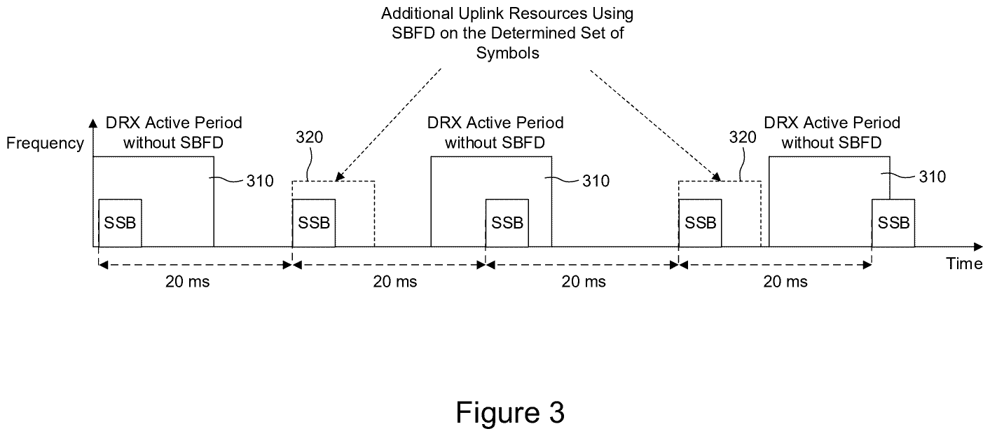

With reference to FIG. 3, the WTRU may request additional cell DRX time. The WTRU is configured with a cell DRX configuration. The cell DRX configuration includes multiple DRX active periods 310, multiple cell DRX inactive periods 320, and a periodicity during which the active periods and inactive periods repeat. The cell DRX active periods 310 may operate without SBFD. The WTRU may be configured with one or multiple SBFD configurations associated with the cell DRX configuration. The WTRU may be configured to associate each logical channel with a logical channel latency parameter. It is noted that the additional cell DRX active period duration that is referenced throughout this detailed description occurs during the cell DRX inactive periods 320.

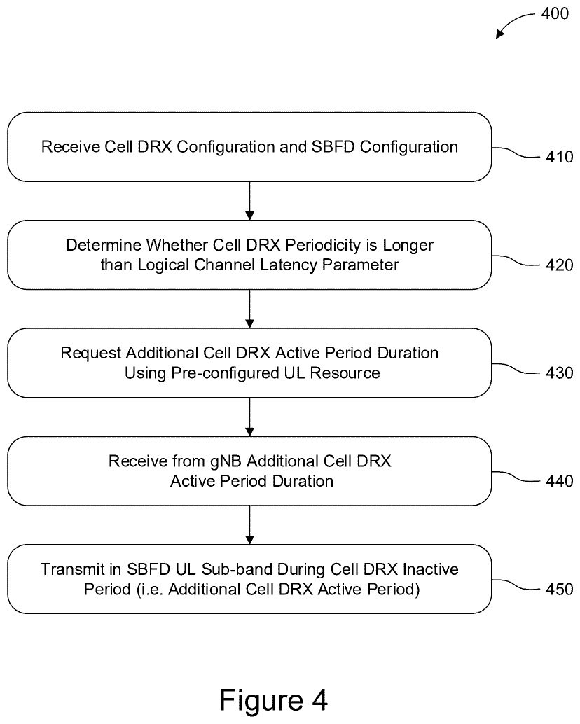

Referring to FIG. 4, a method 400 is implemented by a WTRU for determining whether to request an additional cell DRX active period. The WTRU is configured with both a cell DRX configuration and an SBFD configuration, as described herein above, 410. The WTRU is configured to determine whether additional cell DRX active period duration is needed or not for each logical channel, step 420. If the cell DRX periodicity is longer than the logical channel latency parameter, then the WTRU requests additional cell DRX active period duration from the gNB using a pre-configured uplink resource (e.g., a preconfigured resource for the request outside of the cell DRX active period), step 430. If the logical channel latency parameter is greater than the cell DRX periodicity, the WTRU may wait until the next cell DRX active period to transmit the data corresponding to the logical channel and still satisfy the logical channel latency requirement.

In response to the request, the WTRU may receive from the gNB additional WTRU-specific or WTRU group specific cell DRX active period time, step 440. For example, the WTRU may receive an indication from the gNB to use one of the SBFD configurations associated with a cell DRX configuration and the SSB index (e.g., using group common PDCCH). The WTRU determines the set of symbols and uplink resources for the additional cell DRX active period duration based on the indicated SBFD configuration and the indicated SSB index. The WTRU transmits the uplink transmission in the UL sub-band of the SBFD configuration within the determined set of symbols, step 450. The WTRU may then indicate to the gNB that additional cell DRX active period duration is no longer required when the UE has no logical channel data with a logical channel latency parameter below the cell DRX periodicity.

In some embodiments, the WTRU may be configured, during a cell DRX active period, to transmit UL transmission using the guard band(s) between UL and DL sub-band. In another embodiment, the WTRU may be configured to transmit an UL transmission overlapping with a DL sub-band. For example, a few DL PRBs may be allowed by the gNB to be used for UL transmission and coexist with downlink transmission in the same DL sub-band.

In some embodiments, the WTRU may be configured, during a cell DRX non-active period, to transmit an UL transmission using the guard band(s) between UL and DL sub-band. In another embodiment, the WTRU may be configured to transmit an UL transmission overlapping with a DL sub-band. For example, a few DL PRBs may be allowed by the gNB to be used for UL transmission and coexist with downlink transmission in the same DL sub-band.

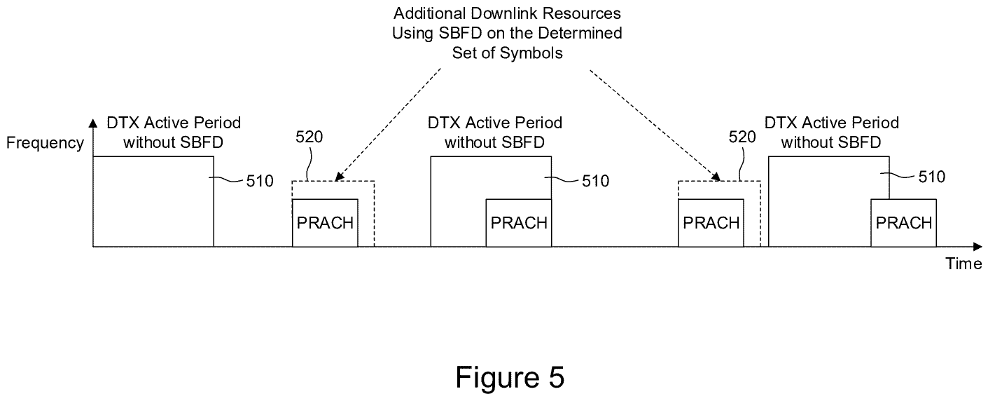

With reference to FIG. 5, the WTRU may request additional cell DTX time. The WTRU is configured with a cell DTX configuration. The cell DTX configuration includes multiple DTX active periods 510, multiple cell DTX inactive periods 520, and a periodicity during which the active periods and inactive periods repeat. The cell DTX active periods 510 may operate without SBFD. The WTRU may be configured with one or multiple SBFD configurations associated with the cell DTX configuration. It is noted that the additional cell DTX active period duration that is referenced throughout this detailed description occurs during the cell DTX inactive periods 520.

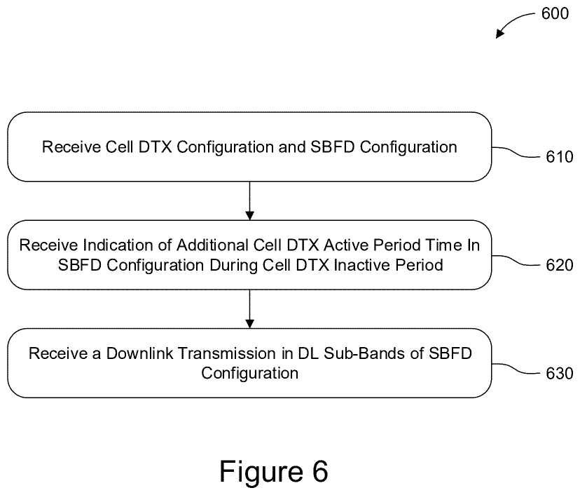

Referring to FIG. 6, a method 600 is implemented by a WTRU for operating with an additional cell DTX active period. The gNB may determine to initiate additional cell DTX active periods for a variety of reasons, including load balancing and management of other network conditions. The WTRU is configured with a cell DTX configuration, including cell DTX active periods, cell DTX inactive periods, and a cell DTX periodicity at which the active and inactive periods repeat. The WTRU is also configured with one or multiple SBFD configurations associated with the configured cell DTX operation. The WTRU receives information regarding the cell DTX configuration and the cell SBFD configuration, step 610. The WTRU receives an indication of additional WTRU-specific or WTRU group specific cell DTX active period time to monitor downlink transmissions in additional active duration, step 620. For example, the WTRU may receive an indication from the gNB to use one of the SBFD configurations associated with a cell DTX configuration (e.g., using group common PDCCH) during the next PRACH occasion. The indication may include a set of symbols for which the SBFD configuration is valid. The WTRU receives a downlink transmission in the DL sub-band(s) of the SBFD configuration within the determined set of symbols, step 630. Further, the WTRU may receive an indication to disable the additional WTRU-specific or WTRU group specific cell DTX active period time. In such a case, the WTRU stops monitoring downlink transmission outside the cell DTX active period duration.

In some embodiments, the WTRU may be configured during a cell DTX active period to receive a DL transmission using the guard band(s) between UL and DL sub-band. In another embodiment, the WTRU may be configured to receive a DL transmission within an UL sub-band. For example, a few UL PRBs may be allowed by the gNB to be used for DL transmission and coexist with uplink transmission in the same UL sub-band.

In some embodiments, the WTRU may be configured during a cell DTX non-active period to receive a DL transmission using the guard band(s) between an UL and DL sub-band. In another embodiment, the WTRU may be configured to receive a DL transmission within an UL sub-band. For example, a few UL PRBs may be allowed by the gNB to be used for DL transmission and coexist with uplink transmission in the same UL sub-band.

In other embodiments, the SBFD configurations may be adapted. The WTRU may be pre-configured with multiple cell DRX and/or cell DTX configurations. The WTRU may also be pre-configured with multiple SBFD configurations. In one embodiment, the WTRU is configured with at least three SBFD configuration associated with a single cell DTX and/or cell DRX configuration. Specifically, a first SBFD configuration is associated with cell DTX active period duration and/or cell DRX active period duration, a second SBFD configuration is associated with a cell DTX-OFF duration and/or a cell DRX active period duration, and a third SBFD configuration may be activated/deactivated dynamically. In such a scenario, the WTRU may receive an indication to enable a cell DRX and/or cell DTX configuration. The WTRU activates the first SBFD configuration associated with the cell DTX active period and/or cell DRX active period during active duration and activates the second SBFD configuration associated with the cell DTX non-active and/or cell DRX non-active duration during non-active duration. The WTRU monitors for SSB within the DL sub-band in the active SBFD configuration and initiates random access if needed. The WTRU may transmit a PRACH in UL sub-band in the active SBFD configuration, and the WTRU may monitor for RAR in the DL sub-band the active SBFD configuration. The WTRU may receive an indication to enable the third SBFD configuration associated with the cell DTX and/or cell DRX pattern. Such an indication may be an indication to the WTRUs in a RAR response, a group common DCI indicating the activation of the third SBFD configuration, and/or a RAR scheduling an UL transmission and indicating the activation of the third SBFD configuration. The WTRU may autonomously activate/enable the third SBFD configuration, where more PRACH resources are allocated in the third SBFD configuration when the WTRU fails to receive a RAR response for a configured time (e.g., failing to receive a RAR response within the SSB periodicity).

In other embodiments, the WTRU may use power ramping. The WTRU is pre-configured with cell DRX and/or cell DTX configurations. The WTRU is configured with an association between an SBFD configuration and a cell DRX and/or cell DTX configuration. The SBFD configuration includes an uplink subband with PUCCH/PRACH occasions and a DL sub-band for SSB transmission. The WTRU receives an indication to activate one cell DRX configuration and/or one cell DTX configuration. The WTRU determines the SSB occasions and at least one of the SSB transmission occasions are within a cell DTX non-active period. In this case, the WTRU determines a set of symbols that are associated with SSB transmission occasions within the cell DTX non-active period. The WTRU determines the set of symbols based on one or more of the following: DTX periodicity, and/or a slot number of the SSB occasion. The WTRU assumes the SBFD configuration associated with the activated cell DTX and/or cell DRX configuration within the determined set of symbols. The WTRU determines whether to use 2-step RACH or 4-step RACH based on the number of the set of symbols. The WTRU transmits a PRACH on the UL sub-band of the SBFD configuration. The WTRU sets the RAR timer value based on the number of the set of symbols. The WTRU monitors for RAR on the DL sub-band of the SBFD configuration within the set of symbols. And in the absence of an RAR, the WTRU selects the power ramping step based on the number of the set of symbols.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
receiving, from a gNode-B (gNB), a sub-band full duplex (SBFD) configuration;
receiving, from the gNB, a cell discontinuous reception (DRX) configuration indicative of a cell DRX active period and a cell DRX periodicity;
determining that a latency parameter associated with packet data for transmission is longer than the cell DRX periodicity;
transmitting, to the gNB, a request using a preconfigured uplink resource;
receiving, from the gNB, an indication of SBFD resources for uplink transmission during a cell DRX inactive period; and
transmitting, to the gNB, the packet data using the SBFD resources for uplink transmission.

2. The method of claim 1, wherein the SBFD resources for uplink transmission overlap with a synchronization signal/physical broadcast channel (PBCH) block (SSB) transmission by the gNB.

3. The method of claim 1, wherein the SBFD resources for uplink transmission overlap with a paging occasion, a physical downlink control channel (PDCCH) occasion, or a reference signal.

4. The method of claim 1, wherein the SBFD resources for uplink transmission overlap with an SBFD downlink transmission by the gNB.

5. The method of claim 1, wherein the latency parameter associated with packet data for transmission is associated with a logical channel associated with the packet data for transmission.

6. The method of claim 1, wherein the preconfigured uplink resource is a physical uplink control channel (PUCCH) resource.

7. The method of claim 1, wherein the preconfigured uplink resource is an SBFD resource during a cell DRX inactive period.

8. The method of claim 1, further comprising:
retransmitting the request to the gNB using a preconfigured uplink resource.

9. The method of claim 1, wherein the indication of SBFD resources for uplink transmission during a cell DRX inactive period is received in a physical downlink control channel (PDCCH) search space.

10. The method of claim 1, further comprising:
receiving, from the gNB, an indication that SBFD resources for uplink transmission during a cell DRX inactive period are no longer available.

11. A wireless transmit/receive unit (WTRU), the WTRU comprising:
a transceiver configured to receive, from a gNode-B (gNB), a sub-band full duplex (SBFD) configuration;
the transceiver further configured to receive, from the gNB, a cell discontinuous reception (DRX) configuration indicative of a cell DRX active period and a cell DRX periodicity;
a processor configured to determine that a latency parameter associated with packet data for transmission is longer than the cell DRX periodicity;
the transceiver further configured to transmit, to the gNB, a request using a preconfigured uplink resource;
the transceiver further configured to receive, from the gNB, an indication of SBFD resources for uplink transmission during a cell DRX inactive period; and
the transceiver further configured to transmit, to the gNB, the packet data using the SBFD resources for uplink transmission.

12. The WTRU of claim 11, wherein the SBFD resources for uplink transmission overlap with a synchronization signal/physical broadcast channel (PBCH) block (SSB) transmission by the gNB.

13. The WTRU of claim 11, wherein the SBFD resources for uplink transmission overlap with a paging occasion, a physical downlink control channel (PDCCH) occasion, or a reference signal.

14. The WTRU of claim 11, wherein the SBFD resources for uplink transmission overlap with an SBFD downlink transmission by the gNB.

15. The WTRU of claim 11, wherein the latency parameter associated with packet data for transmission is associated with a logical channel associated with the packet data for transmission.

16. The WTRU of claim 11, wherein the preconfigured uplink resource is a physical uplink control channel (PUCCH) resource.

17. The WTRU of claim 11, wherein the preconfigured uplink resource is an SBFD resource during a cell DRX inactive period.

18. The WTRU of claim 11, wherein the transceiver is further configured to retransmit the request to the gNB using a preconfigured uplink resource.

19. The WTRU of claim 11, wherein the indication of SBFD resources for uplink transmission during a cell DRX inactive period is received in a physical downlink control channel (PDCCH) search space.

20. The WTRU of claim 11, wherein the transceiver is further configured to receive, from the gNB, an indication that SBFD resources for uplink transmission during a cell DRX inactive period are no longer available.
